(19) United States
(12) Patent Application Publication
(10) Pub. No.: US 2006/0108471 A1
(43) Pub. Date: May 25, 2006

(54) Method and system for maintenance, in particular disassembly, of gas turbines

(75) Inventor: Detlef Renner, Hattorf/Harz (DE)

Correspondence Address: CROWELL & MORING LLP;INTELLECTUAL PROPERTY GROUP, P.O. BOX 14300, WASHINGTON, DC, 20044-4300, US

(73) Assignee: MTU Aero Engines GmbH, Muenchen (DE)

(21) Appl. No.: 10/522,921

(22) PCT Filed: Mar. 29, 2004
(86) PCT No.: PCT/DE04/00655

§ 371 Date: Sep. 20, 2005

(30) Foreign Application Priority Data
Apr. 27, 2003 (DE) 10319017.1

(51) Int. Cl. F02K 1/00

(52) U.S. Cl. 244/62; 60/200.1

(57) ABSTRACT

A system and method for maintenance, in particular disassembly, of gas turbines, in particular aircraft engines, wherein a gas turbine is introduced, before being disassembled, into a first apparatus which is at least largely sealed against a cleaning agent being emitted therein, the gas turbine is cleaned in the first apparatus, and is removed from the first apparatus after having been cleaned and then passed on for disassembly.

This application claims the priority of German application no. 10319017.1 dated Apr. 27, 2003, and PCT International Patent Application No. PCT/DE2004/000655, filed Mar. 29, 2004, the disclosure of which is expressly incorporated by reference herein.

### BACKGROUND AND SUMMARY OF THE INVENTION

The invention relates to a method for maintenance, in particular disassembly, of gas turbines, that is to say aircraft engines or stationary gas turbines, and to a system for maintenance, in particular disassembly, of gas turbines, that is to say aircraft engines or stationary gas turbines.

The maintenance and servicing of gas turbines, in particular aircraft engines, is becoming a critical factor when determining the direct operating costs of an aircraft. For example, approximately 30% of the direct operating costs of an aircraft can be attributed to the aircraft engines, with about a third of the operating costs relating to the engines being attributed to the servicing of the aircraft engines. The costs for servicing of aircraft engines therefore amount to about 10% of the total direct operating costs of an aircraft. It follows directly from this that efficient and low-cost servicing and servicing maintenance of aircraft engines is of critical importance to the airlines. A similar situation also applies to stationary gas turbines.

Until now, the servicing and maintenance of gas turbines, in particular of aircraft engines, has been based on the so-called workshop principle. In the so-called workshop principle, the gas turbine remains, at least in some cases, at one position or at one location. The material, tools and personnel required to carry out the work are made available for the gas turbine or the aircraft enginee at times such that as few disturbances as possible occur, and such that a promised servicing time can be complied with.

The servicing and maintenance of gas turbines, in particular aircraft engines, based on the so-called workshop principle, has the disadvantage, however, that the servicing process does not follow a defined structure. In fact, work is carried out on the gas turbine or on the aircraft enginee in virtually any desired sequence so that disturbances and delays can occur in the maintenance of gas turbines, particularly when a number of them are being maintained at the same time. Maintenance of gas turbines based on the so-called workshop principle accordingly has the disadvantages that, on the one hand, there is no clear process structure and that, on the other hand, long times are required for servicing and for maintenance. This adversely affected the efficiency for maintenance.

Against this background, the present invention is based on the problem of providing a novel method for maintenance, in particular disassembly, of gas turbines, in particular aircraft engines, and a corresponding system.

According to the invention, a gas turbine is introduced, before being disassembled, into a first apparatus which is at least largely sealed against a cleaning agent being emitted therein, is cleaned in the first apparatus and is removed from the first apparatus after having been cleaned. The cleaned aircraft engine is then passed on for disassembly. This ensures that externally accessible dirt and lubricants or the like are removed from the aircraft engine before the disassembly process is started. This has a positive influence on the entire maintenance process. The sealing against cleaning agents being emitted avoids this contamination of other areas outside the first apparatus.

According to one advantageous development of the invention, a gas turbine to be maintained is positioned in the first apparatus for cleaning. After being cleaned, the gas turbine is transferred, with a feed device being changed, from the first apparatus to a second apparatus, which is used for disassembly of the gas turbine. This ensures that the dirt and lubricants which have been removed during the cleaning of the gas turbine do not enter the area of the second apparatus, which is used for disassembly of the gas turbine.

Other objects, advantages and novel features of the present invention will become apparent from the following detailed description of the invention when considered in conjunction with the accompanying drawings.

### BRIEF DESCRIPTION OF THE DRAWINGS

FIG. 1 shows a schematic plan view of a system according to an embodiment of the invention having a first apparatus for cleaning an aircraft engine and having a second apparatus for disassembling it, together with an aircraft engine which is arranged outside the first apparatus and is positioned on a forklift truck;

FIG. 2 shows the arrangement as shown in FIG. 1, with the aircraft engine being positioned by the forklift truck in the first apparatus;

FIG. 3 shows the arrangement as shown in FIGS. 1 and 2 with the aircraft engine positioned in the first apparatus, and with the forklift truck having been moved away from the first apparatus;

FIG. 4 shows an aircraft engine, positioned in the first apparatus, in a view from underneath, while it is being cleaned;

FIG. 5 shows an aircraft engine positioned in the first apparatus, in a view from above, while it is being cleaned;

FIG. 6 shows the arrangement as shown in FIGS. 4 and 5, with the cleaned aircraft engine having been moved out of the first apparatus and being positioned on a feed device, which is downstream from the first apparatus, for the second apparatus; and

FIG. 7 shows the arrangement as shown in FIG. 6, with the cleaned aircraft engine being positioned on a feed device which is arranged downstream from the first apparatus.

### DETAILED DESCRIPTION

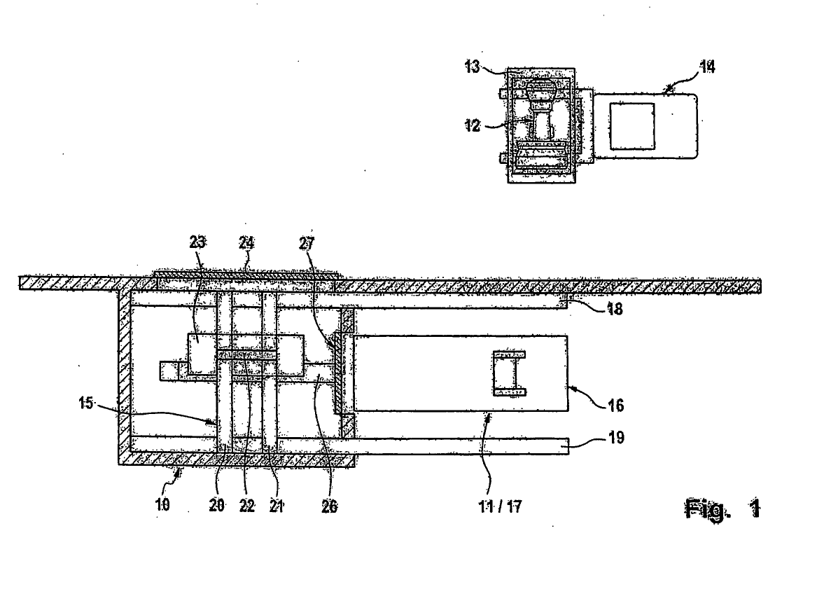

FIGS. 1 to 7 show an embodiment of a system according to the invention for maintenance, in particular disassembly, of gas turbines using the example of an aircraft engine. The present invention in this case relates to the cleaning and subsequent disassembly of an aircraft engine for its maintenance of servicing. A system for maintenance of aircraft engines may accordingly have further apparatuses which are not shown in FIGS. 1 to 7, in order to simplify the illustration of the invention.

FIG. 1 shows an embodiment of a system for maintenance, servicing or repair of an aircraft engine. This system has a first apparatus 10 for cleaning an aircraft engine as well as a second apparatus 11, which is arranged downstream from the first apparatus 10, for disassembly of the aircraft engine. In FIG. 1, an aircraft engine 12 to be maintained is positioned outside the system or the first apparatus 10 and the second apparatus 11. FIG. 1 thus shows that the aircraft engine 12 to be maintained is arranged on a transport frame 13, which is positioned together with the aircraft engine 12 on a forklift truck 14.

The first apparatus 10 for cleaning the aircraft engine 12 has a first feed device 15 associated with it. In the illustrated exemplary embodiment, the first feed device 15 is in the form of a feed crane. The second apparatus 11 for disassembly of the aircraft engine 12 has a second feed device 16 associated with it. The second feed device 16 is used to move the aircraft engine 12 through two or more workstations, which are arranged in succession, in the second apparatus 11 for disassembly of the aircraft engine 12. FIGS. 1 to 7 show only a first workstation 17 in the second apparatus 11 for disassembly of the aircraft engine 12 and, respectively a corresponding detail of the second feed device 16. The first workstation 17 in the second apparatus 11 for disassembly of the aircraft engine 12 follows the first apparatus 10 for cleaning of the aircraft engine 12.

The apparatus 10 for cleaning the aircraft engine is in the form of a washing area or washing chamber, with the first feed device 15, which is in the form of a feed crane, being positioned within the washing area. The first feed device 15 or the feed crane has two longitudinal supports 18, 19, which are arranged at a distance from one another and run essentially parallel to one another. The two longitudinal supports 18, 19 extend on the one hand over the entire width of the first apparatus 10 for cleaning the aircraft engine 12, and on the other hand they also extend into the area of the first workstation 17 in the second apparatus for disassembly of the aircraft engine 12. In addition to the two longitudinal supports 18, 19, the first feed device 15, which is in the form of a feed crane, has two transverse supports 20, 21. The transverse supports 20, 21 can be moved along the longitudinal supports 18, 19. A strut 22 acts on the transverse supports 20, 21 and can be moved over the entire range of the transverse support 20, 21, and thus between the two longitudinal supports 18, 19. An adapter 23 for holding an aircraft engine is attached to the strut 22, in which case the adapter 23 can be moved up and down relative to the strut 22. The relative movement of the transverse supports 20, 21 relative to the longitudinal supports 18, 19, the relative movement of the strut 22 relative to the transverse supports 20, 21 and the relative movement of the adapter 23 allow a three-dimensional movement of an aircraft engine 12 which is positioned in the adapter 23. The adapter 23 is designed such that it can hold a large number of different aircraft engines 12. The aircraft engines are standard production engines and are familiar to those skilled in the art addressed here.

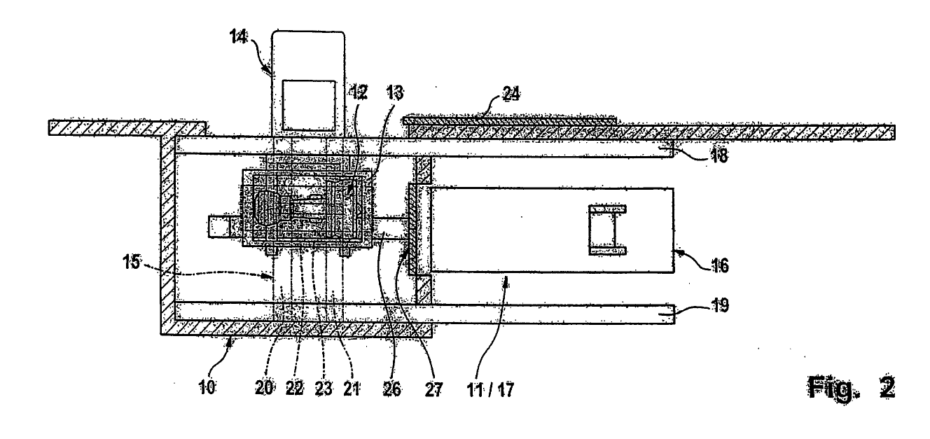

In order to clean an aircraft engine 12 which is to be maintained or repaired, the aircraft engine 12 is now positioned in a first step (see FIG. 2) with the aid of the forklift truck 14 in the first apparatus 10, which is in the form of a washing chamber. For this purpose, a side door 24 is opened, so that the forklift truck 14 can move the aircraft engine 12, which is held by the transport frame 13, into the first apparatus 10, and can position it underneath the first feed device 15, which is in the form of a feed crane.

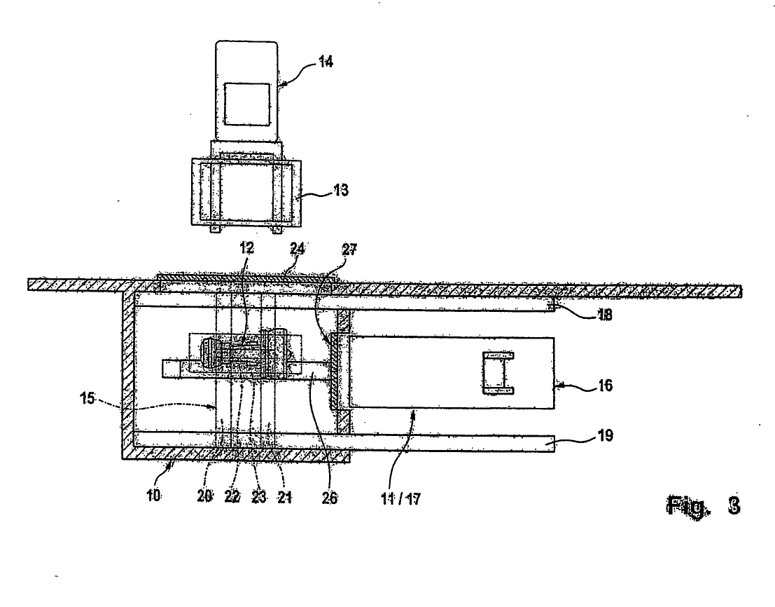

In the next step, the aircraft engine 12 to be maintained or repaired is picked up by the adapter 23 on the first feed device 15. This can be seen in particular from FIG. 3. The forklift truck 14 is then moved, together with the transport frame 13, out of the first apparatus 10, which is in the form of a washing chamber, and the door 24 is closed again.

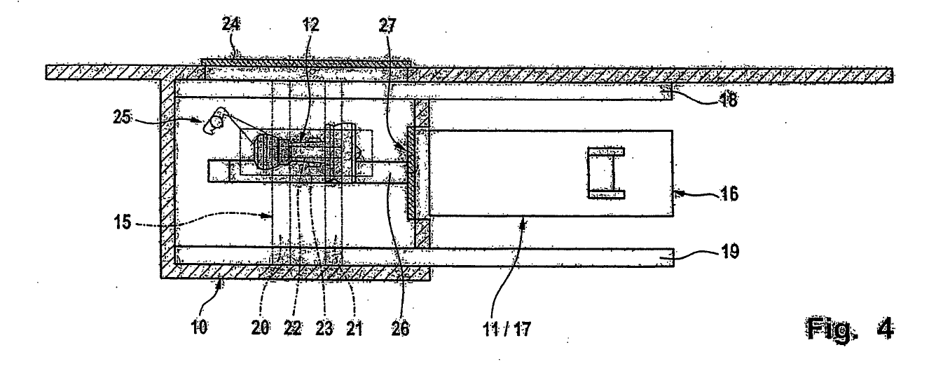

The process of cleaning the aircraft engine 12 is then started. In this context, FIG. 4 shows an operator 25 spraying a cleaning agent, or using a jet of cleaning agent, onto the aircraft engine 12. Prior to this, the operator 25 has allowed the liquids and lubricants or the like to flow out of the aircraft engine 12. In FIG. 4, the operator 25 is standing on the floor of the washing chamber, and is accordingly cleaning the aircraft engine 12 from underneath and from the side. Since the aircraft engine 12 is suspended on the first feed device 15, which is in the form of a feed crane, the aircraft engine 12 is freely accessible while it is being cleaned. It can therefore be cleaned from all sides.

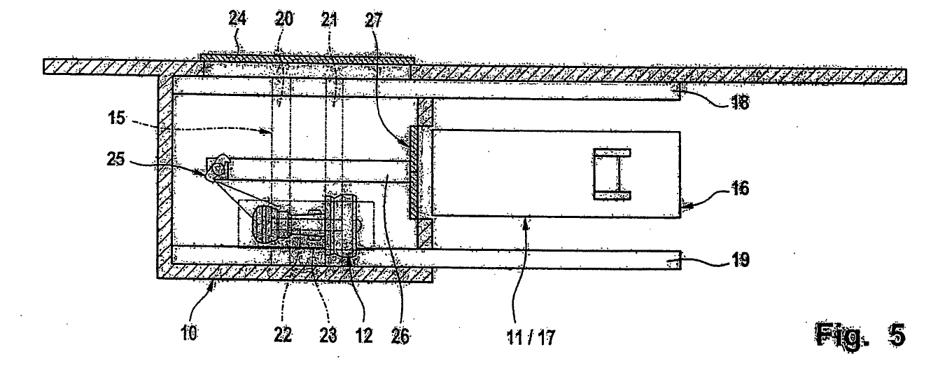

In order to clean the aircraft engine 12 from above, the operator 25 enters a cage 26 which is arranged within the first apparatus 10. This is illustrated in FIG. 5. As can also be seen from FIG. 5, the aircraft engine 12 is moved backwards and forwards along the transverse struts 20, 21 in order to clean it thoroughly. This ensures that the operator 25 can clean the aircraft engine 12 from all sides, and accordingly that all areas of the aircraft engine 12 to be cleaned are easily accessible. The first apparatus 10 is at least largely sealed against cleaning agent being emitted.

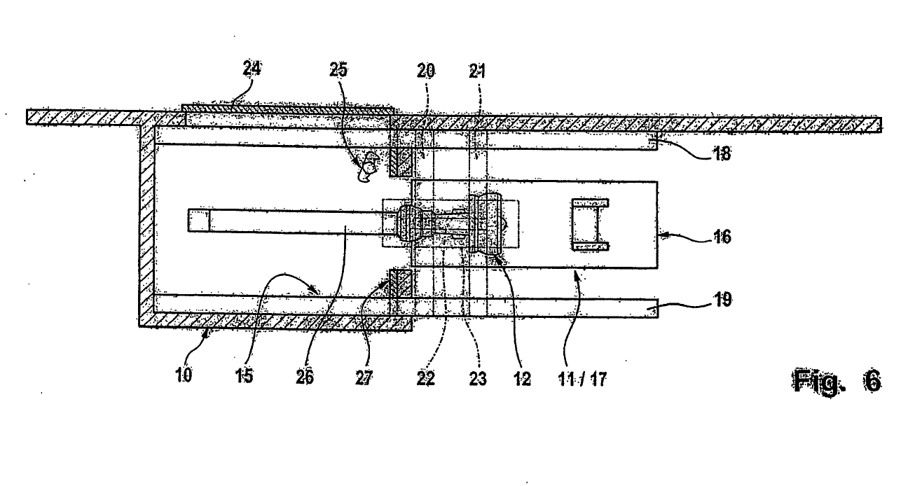

Once the aircraft engine 12 has been cleaned, a further door 27 in the first apparatus 10, which is in the form of a washing chamber, is opened. This can be seen in particular from FIG. 6. Furthermore, the first feed device 15 is used to move the aircraft engine 12 out of the first apparatus 10 and into the area of the first workstation 17 in the second apparatus 11 for disassembly of the aircraft engine. FIG. 6 thus shows that relative movement of the transverse supports 20, 21 along the longitudinal supports 18, 19 results in the aircraft engine 12 being moved into the area of the first workstation 17 in the second apparatus 11 for disassembly of the aircraft engine 12.

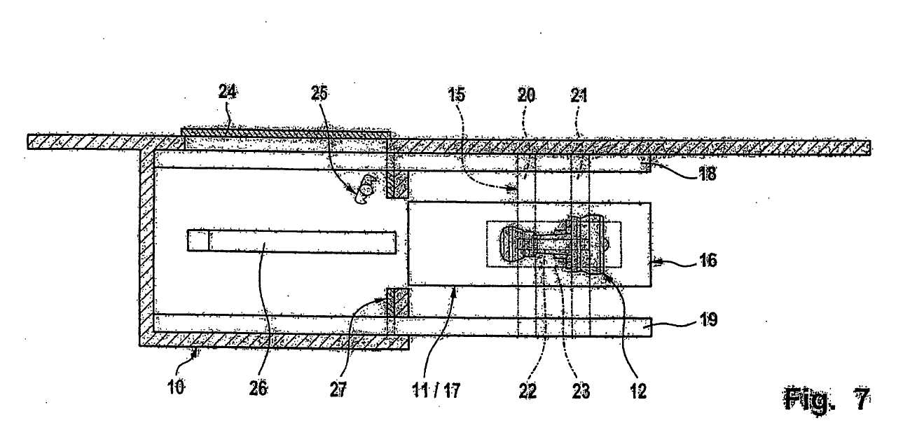

As is shown in FIG. 7, once the aircraft engine 12 has been cleaned, it is placed down in the area of the first workstation 17 and is accordingly transferred from the first feed device 15 to the second feed device 16, which then moves the aircraft engine 12 to be maintained or to be repaired through a number of workstations, which are arranged in succession, in the second apparatus 11 for disassembly, although FIGS. 1 to 7 illustrate only the first workstation 17.

Accordingly, it is within the scope of the present invention in this case for the aircraft engine 12 to be cleaned as a unit before it is actually maintained, serviced or repaired. The aircraft engine 12 is not passed to the disassembly stage until it has been cleaned. The aircraft engine 12 is cleaned in a separate apparatus 10. The apparatus 10 for cleaning the aircraft engine 12 has a feed device 15 associated with it. Once the aircraft engine 12 has been cleaned, the cleaned aircraft engine 12 is moved out of the first apparatus 10 by means of the first feed device 15, and is passed to the first workstation 17 in the second apparatus 11, which is used for disassembly of the aircraft engine 12. The aircraft engine 12 is placed down on a second feed device 16 in the first workstation 17, with the second feed device 16 moving the aircraft engine through two or more workstations, which follow the first workstation 17 and are arranged in succession, for disassembly. Once the aircraft engine 12 has been cleaned, the feed devices are accordingly changed. This ensures that dirt that has been removed and liquids which have been let out, such as lubricants or the like, do not enter the area of the second feed device 16 or the workstations in the apparatus 11 for disassembly of the aircraft engine 12. The dirt remains in the area of the first apparatus 10 and the first feed device 15.

The removal of the dirt before the actual disassembly of the aircraft engine 12 noticeably improves the disassembly process. This is because the aircraft engine 12 has already been cleaned before the disassembly process. Less effort is then required to disassemble the aircraft engine 12. A further advantage of the method according to the invention and of a system according to the invention is that the dirt is detached from the aircraft engine 12 only in a small, limited area of a maintenance or repair building. In the other sections of the maintenance or repair building, an aircraft engine 12 from which the worst dirt has already been removed is disassembled, inspected, repaired and then reassembled.

The method according to the invention as well as the system according to the invention are particularly advantageous when the aircraft engine 12 is maintained using the so-called conveyor belt principle. When an aircraft engine 12 is being maintained and disassembled using the conveyor belt principle, dirt in the area of the feed device which moves the aircraft engine 12 to be disassembled through workstations which are arranged in succession is particularly disadvantageous since the dirt can adversely affect the operation of the feed device.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1. A method for maintenance, of gas turbines, wherein a gas turbine is introduced, before being disassembled, into a first apparatus which is at least largely sealed against a cleaning agent being emitted therein, the gas turbine is cleaned in the first apparatus, and is removed from the first apparatus after having been cleaned and the cleaned gas turbine is then passed on for disassembly.

2. The method as claimed in claim 1, wherein a gas turbine to be maintained or to be cleaned is positioned in the first apparatus, and the gas turbine is then cleaned all over as a unit.

3. The method as claimed in claim 2, wherein liquids, are let out from the gas turbine, positioned in the first apparatus, before the cleaning of the gas turbine.

4. The method as claimed in claim 1, wherein after it has been cleaned, the gas turbine is moved, with a first feed device, from the first apparatus to a second apparatus for disassembly.

5. The method as claimed in claim 4, wherein the first feed device is a feed crane and can be matched to different types of gas turbines to be maintained and/or to be cleaned.

6. The method as claimed in claim 4, wherein after being cleaned, the gas turbine is moved out of the first apparatus with the aid of the first feed device, and the cleaned gas turbine is then positioned on a second feed device for disassembly.

7. The method as claimed in claim 6, wherein for disassembly, the cleaned gas turbine is moved by the second feed device through a number of workstations, which are arranged in succession, in the second apparatus.

8. The method as claimed in claim 7, wherein the gas turbine is moved by the second feed device on a cycle through workstations, which are arranged in succession, in the second apparatus.

9. The method as claimed claim 1, wherein after being disassembled, at least one of modules, assemblies and individual parts of the gas turbine are inspected, and the gas turbine is then assembled from inspected new modules, assemblies or individual parts.

10. A system for maintenance, of gas turbines, wherein an apparatus for disassembly of a gas turbine is preceded by an apparatus for cleaning the gas turbine, wherein the apparatus for cleaning is at least largely sealed against a cleaning agent being emitted therein.

11. The system as claimed in claim 10, wherein the apparatus for cleaning the gas turbine has a first feed device, and wherein the first feed device can be matched via an adapter to different types of gas turbines to be maintained.

12. The system as claimed in claim 11, wherein the first feed device is in the form of a feed crane, and wherein the gas turbine can be moved on three axes by the first feed device within the apparatus for cleaning of the gas turbine.

13. The system as claimed in claim 10, wherein the apparatus for disassembly of the gas turbine has a second feed device, and wherein the second feed device can be matched via an adapter to different types of gas turbine to be maintained.

14. The system as claimed in claim 13, wherein the gas turbine can be moved by the second feed device through a number of workstations, which are arranged in succession, in the apparatus for disassembly.

15. The system as claimed claim 13, wherein a first workstation in the apparatus for disassembly of the gas turbine follows the apparatus for cleaning the gas turbine, and the first feed device extends into at least one of the area of the second feed device and into the area of the first workstation in the apparatus for disassembly, such that the gas turbine, after being cleaned, is transferable by the first feed device to the second feed device.
